(19) United States
(12) Patent Application Publication
(10) Pub. No.: US 2014/0323289 A1
(43) Pub. Date: Oct. 30, 2014

(54) ZEOLITIC ADSORBENTS FOR USE IN ADSORPTIVE SEPARATION PROCESSES AND METHODS FOR MANUFACTURING THE SAME

(71) Applicant: UOP LLC, Des Plaines, IL (US)

(72) Inventors: Jack E. Hurst, Mobile, AL (US); William Craig Schwerin, Mt. Prospect, IL (US); Mark M. Davis, Highland Park, IL (US)

(73) Assignee: UOP LLC, Des Plaines, IL (US)

(21) Appl. No.: 13/869,845

(22) Filed: Apr. 24, 2013

(51) Int. Cl. B01J 20/30; B01J 20/18

(52) U.S. Cl. CPC B01J 20/3042; B01J 20/18
USPC 502/68

(57) ABSTRACT

A method for producing a zeolitic adsorbent includes providing a zeolite material, providing a zeolite material, providing a first clay binder material and a second clay binder material, the first clay binder material having a greater median particle size than the second clay binder material, determining a desired adsorption kinetics rate for the zeolitic adsorbent, wherein the desired adsorption kinetics rate is based at least in part on a separations process in which the zeolitic adsorbent is desired to be employed, and selecting either the first clay binder material or the second clay binder material based at least in part on the determined desired adsorption kinetics rate. The method further includes blending the zeolite material and the selected first or second clay binder material to form a zeolite/binder blended system, forming a plurality of shaped zeolitic adsorbent pieces from the exchanged zeolite/binder blended system, binder-converting the clay binder material into a zeolite material, and ion-exchanging the binder-converted shaped pieces with an exchange cation to form an ion-exchanged zeolite/binder blended system.

### TECHNICAL FIELD

The present disclosure relates generally to adsorbents useful in adsorptive separation processes. More particularly, the disclosure relates to zeolitic adsorbents useful in separating gaseous species, such as molecular oxygen and nitrogen.

### BACKGROUND

Processes exist for separating feed streams containing molecules having differing sizes, shapes, and adsorption selectivities by contacting the feed stream with an adsorbent into which one component of the feed stream to be separated is more strongly adsorbed by the adsorbent than the other. The more strongly adsorbed component is preferentially adsorbed by the adsorbent to provide a first product stream that is enriched in the weakly or non-adsorbed component as compared with the feed stream. After the adsorbent is loaded to a desired extent with the adsorbed component, the conditions of the adsorbent are varied, e.g., typically either the temperature of or the pressure upon the adsorbent is altered, so that the adsorbed component can be desorbed, thereby producing a second product stream that is enriched in the adsorbed component as compared with the feed stream.

Adsorption processes are inherently batch processes where the adsorbent will selectively adsorb an impurity from a process stream while producing a product stream where the impurity is substantially reduced or eliminated. The impurity will adsorb on the solid adsorbent until the impurity in the product stream reaches a predetermined level. The sorbent must then be regenerated to release the impurity so that the sorbent can again be used to remove impurity from the feed process stream. Faster adsorption and desorption kinetics allows for faster cycling, which reduces the required adsorbent inventory and the size of the process vessel that contains the adsorbent, which in turn reduces capital investment. Also, for a fixed set of process conditions faster kinetics will allow closer approach to equilibrium loadings for both adsorption and desorption which increases the process efficiency which reduces the process capital and operating expense.

Important factors in such processes include the capacity of the molecular sieve for the more strongly adsorbable components and the selectivity of the molecular sieve (i.e., the ratio in which the components to be separated are adsorbed). In some such processes, zeolites are the preferred adsorbents because of their high adsorption capacity at low partial pressures of adsorbates and may be chosen so that their pores are of an appropriate size and shape to provide a high selectivity in concentrating the adsorbed species. In other such processes, particularly with regard to the nitrogen/oxygen separation processes described herein, zeolites are the preferred adsorbents due to their ability to separate nitrogen and oxygen based upon nitrogen's quadropole energy interaction with the cations on the zeolite. Often the zeolites used in the separation of gaseous mixtures are synthetic (i.e., manufactured) zeolites.

For example, in pressure swing adsorption, transport from the bulk fluid to the solid sorbent through the pore network is accomplished not only by molecular diffusion and Knudsen diffusion but also by convective transport due to the pressurization and depressurization steps in the process. The size, structure, and distribution of the pore network of the adsorbent have a very significant impact on the kinetics of the process. For example, the effective pore opening diameter influences not only the molecular sieving effect and co-adsorption but also dynamic adsorption processes. In particular the effective pore opening diameter influences mass transfer rates by limiting the rate of diffusion of molecules into and out of the zeolite cavity through the pore. In general, the smaller the pore, the lower the rate of diffusion, and as the pore opening approaches the effective diameter of the molecule, the diffusion limitation may become very severe. If the pore is made too small, the equilibrium loading advantage achieved by limiting co-adsorption may be partially or completely negated by reduced rates of mass transfer when the zeolite is used in commercial applications.

Accordingly, it is desirable to provide adsorbent and methods for the manufacture of adsorbents with optimized pore networks to enhance the kinetics of the adsorbents. Further, it is desirable to provide methods for the manufacture of adsorbents that allow for precise control of the pore diameter of the adsorbents to accomplish the optimized pore networks. These and other desirable features and characteristics will become apparent from the subsequent detailed description and the appended claims, taken in conjunction with the accompanying drawings and the foregoing technical field and background.

### BRIEF SUMMARY

Zeolitic adsorbents and methods of manufacturing zeolitic adsorbents are provided herein.

In one exemplary embodiment of the present disclosure, a method for producing a zeolitic adsorbent includes providing a zeolite material, providing a first clay binder material and a second clay binder material, the first clay binder material having a greater median particle size than the second clay binder material, determining a desired adsorption kinetics rate for the zeolitic adsorbent, wherein the desired adsorption kinetics rate is based at least in part on a separations process in which the zeolitic adsorbent is desired to be employed, and selecting either the first clay binder material or the second clay binder material based at least in part on the determined desired adsorption kinetics rate. The method further includes blending the zeolite material and the selected first or second clay binder material to form a zeolite/binder blended system, forming a plurality of shaped zeolitic adsorbent pieces from the exchanged zeolite/binder blended system, binder-converting the clay binder material into a zeolite material, and ion-exchanging the binder-converted shaped pieces with an exchange cation to form an ion-exchanged zeolite/binder blended system.

In another exemplary embodiment of the present disclosure, a zeolitic adsorbent includes a zeolite material and a clay binder material. The clay binder material is selected from a group consisting of a first clay binder material having a median particle size of about 3.50 microns and a second clay binder material having a median particle size of about 1.36 microns. The clay binder material is selected based at least in part upon an adsorption kinetics rate of a separations process in which the zeolitic adsorbent is desired to be employed. Further, the zeolite material and the clay binder material are blended together to form a zeolite/clay binder system. Further, the zeolite/clay binder system is binder-converted to form a binder-converted zeolite material. Still further, the binder converted zeolite material is ion-exchanged with an exchange cation to form a binderless, ion-exchanged, zeolitic adsorbent.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The embodiments of the present disclosure will hereinafter be described in conjunction with the following drawing figures, wherein like numerals denote like elements, and wherein:

FIG. 1 is a bar graph illustrating the median pore diameter of exemplary zeolitic adsorbents formed in accordance with exemplary embodiments of the present disclosure;

FIG. 2 is a scatterplot showing the influence of the median pore diameter of exemplary zeolitic adsorbents on a first measurement of the separation kinetics of an exemplary nitrogen/oxygen separations process;

FIG. 3 is a scatterplot showing the influence of the median pore diameter of exemplary zeolitic adsorbents on a second measurement of the separation kinetics of an exemplary nitrogen/oxygen separations process; and

FIG. 4 is a flowchart illustrating an exemplary method for manufacturing a zeolitic adsorbent in accordance with various embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments and implementations of the zeolitic adsorbents and methods for the manufacture thereof described herein are exemplary embodiments provided to enable persons skilled in the art to make or use the invention and not to limit the scope of the invention, which is defined by the claims. Furthermore, there is no intention to be bound by any expressed or implied theory presented in the preceding technical field, background, brief summary, or the following detailed description.

Embodiments of the present disclosure generally relate to adsorbents and methods of manufacturing adsorbents wherein the selection of the clay particle size used as a binder material is optimized to produce a pore network within the adsorbent that enhances the kinetics of the adsorbent for a particular application by controlling the adsorbent density and the adsorbent median pore diameter (as measured Hg porosimetry), as will be described in greater detail below. Proper selection of the clay particle size can enhance the rate characteristics of the finished product adsorbent. It has been discovered by the Applicants herein that when the clay particles are too small, they will pack in between the zeolite crystals and reduce the intrinsic porosity of the packed zeolite crystals. If the particles are larger and approaching the size of the zeolite crystal, the clay particles may create bridging between zeolite crystals enhancing the porosity and median pore size that is inherent to the packed crystals. Within these parameters, appropriate selection of a clay binder material may be made to produce an optimized adsorbent for a particular application, such as a pressure swing adsorption process.

In an exemplary implementation, the adsorbent described herein may be used in processes for the generation of oxygen from a gaseous mixture. A particularly useful adsorbent for this application includes an X-type zeolite (“zeolite X”) blended with a clay binder material, wherein the clay binder material includes a kaolin-type clay. Further, for this exemplary implementation, the zeolite X is lithium ion-exchanged, preferably after blending.

As is well-known to those having ordinary skill in the art, zeolites are hydrated metal alumino silicates having the general formula:

M_{2/n}O:Al₂O₃:xSiO₂:yH₂O

where M usually represents a metal, n is the valence of the metal M, x varies from 2 to infinity, depending on the zeolite structure type, and y designates the hydrated status of the zeolite. Most zeolites are three-dimensional crystals with a crystal size in the range of 0.1 to 30 μm. Heating these zeolites to high temperatures results in the loss of the water of hydration, which leaves a crystalline structure with channels of molecular dimensions and offers a high surface area for adsorption of inorganic or organic molecules. As noted above, the adsorption of these molecules is limited by the size of the zeolite channels. The rate of adsorption is further limited by the laws of diffusion.

One limitation on the utilization of zeolite crystals is their extremely fine particle size. Large, naturally-formed agglomerates of these crystals break apart easily. Because the pressure drop through a bed containing zeolite particle is often prohibitively high, zeolite crystals alone cannot be used in fixed beds for various dynamic applications, such as the drying of natural gas, drying of air, separation of impurities from a gas stream, separation of liquid product streams, generation of oxygen from a gaseous mixture, and the like. Therefore, it is desirable to blend these crystals with binder materials to provide an agglomerate mass of the crystals, which exhibits a reduced pressure drop.

To permit the utilization of these zeolite crystals, different types of clays are conventionally used as binder materials with the crystals, including attapulgite, palygorskite, kaolin, sepiolite, bentonite, montmorillonite and mixtures thereof. The clay content of a blended zeolite can vary from as low as 1 percent to as high as 40 percent, by weight, although the preferred range is from about 10 to about 25 percent, by weight.

Zeolites may be present in various ion-exchanged forms. The particularly preferred zeolite utilized in a blend depends upon the adsorbate that is to be adsorbed from the feed stream. When the adsorption process is for the purification of gases, notably by pressure swing adsorption (PSA), vacuum swing adsorption (VSA), vacuum-pressure swing adsorption (VPSA), or temperature swing adsorption (TSA) methods, the preferred zeolites include zeolite A or zeolite X.

As noted above, in the exemplary implementation presently described, the zeolite utilized is zeolite X. This zeolite is specifically designed for the generation of oxygen from a gaseous mixture, such as an air stream. In a particularly preferred process, the zeolite X utilized is a low silica zeolite X, known as “LSX,” or low silica faujasite, known as “LSF”. The general formula for LSF is 2.0 SiO₂:Al₂O₃:1.0 MₚO, wherein “M” represents a metal and “p” represents various numbers depending on the valence of the metal.

Zeolite X generally has a Si:Al equivalent ratio of about 1.0 to about 1.25 with a more preferred ratio of 1 to 1.05. In one example, a synthesized LSF has the following anhydrous chemical composition: 2.0 SiO₂:Al₂O₃:0.75 Na₂O:0.25 K₂O, although the quantity of sodium and potassium ions can vary, sometimes significantly, depending upon the process of manufacture of the LSF.

In some examples, the lithium zeolite X component of the blend is ion-exchanged up to lithium levels above 99%. More broadly, useful X-type zeolites can be formed wherein the zeolite is ion-exchanged with lithium ions only to a level of at least about 75%. In some embodiments, as an optional variation of the presently described process, when the zeolite X is ion-exchanged to levels between about 75% and about 99%, additional ion exchange of the remaining cations of the zeolite crystals is performed, which generally comprise sodium and/or potassium cations, with from about 0.1% up to 25% of the total cations in the form of divalent cations, including, but not limited to, zinc and alkaline earth metals, such as calcium, barium, and strontium, preferably calcium, and combinations thereof. Further useful zeolite X crystals can also be produced, wherein the extent of lithium ion exchange is above about 75% with from about 0.1% up to 25% of the remaining metal ions being ion exchanged with trivalent cations, such as, but not limited to, lanthanum and rare earth metals. In addition, the zeolite can be ion-exchanged with combinations of divalent and trivalent ions to levels from about 0.1% up to 25% of the total metal ions of the zeolite X, wherein for example the total metal ions are ion-exchanged at least 75% with lithium.

The lithium-exchanged zeolite X employed in the presently described embodiments has shown particular utility for the generation of oxygen from a gaseous mixture, particularly the separation of nitrogen from oxygen for industrial, commercial, and/or medical purposes. Particularly preferred uses of this zeolite X include the generation of oxygen from a treated air stream (i.e., air having the water and CO₂ removed therefrom) for use in various industries.

Binder materials are utilized initially to agglomerate the individual zeolite X crystals together, to form shaped products and to reduce the pressure drop during the adsorption process, and are thereafter converted to zeolite (as will be described below) to produce a binderless zeolitic adsorbent. However, in prior art products, the binder material has not been identified as a suitable variable for optimizing the adsorption capability of the zeolite. In fact, conventional adsorbent manufacturing methods that use binder materials have generally reduced the adsorption capacity and adsorption rate of the zeolite. Binder materials, which have commonly been utilized with zeolites in the past, include clays, such as kaolin, palygorskite-type minerals, such as attapulgite, and smectite-type clay minerals, such as montmorillonite or bentonite. These clay binders have been used singularly or in mixtures of two or more different types of clay binders.

As noted above, the presently described methods employ a step of binder clay material selection so as to optimize that pore networks within the zeolite adsorbent. In this regard, the properties of two exemplary kaolin-type binder clays are set forth below, for purposes of comparison.

In a first example, chemical and material properties of the kaolin clay known as EPK Kaolin available from Edgar Minerals, Inc. of Edgar, Fla., USA are set forth in Table 1, below.

TABLE 1

| | | | | |
|---|---|---|---|---|
| Chemical Analysis: | SiO₂ | 45.73% | CaO | 0.18 |
| | Al₂0₃ | 37.36 | MgO | 0.098 |
| | Fe₂O₃ | 0.79 | Na₂O | 0.059 |
| | TiO₂ | 0.37 | K₂0 | 0.33 |
| | P₂0₅ | 0.236 | LOI | 13.91 |

Median Particle Size (Microns): about 0.4

In a second example, chemical and material properties of the kaolin clay known as ASP-400P Kaolin available from BASF SE of Ludwigshafen, Germany are set forth in Table 2, below

TABLE 2

| Ingredient | | |
|---|---|---|
| CAS Number | Weight in Percent (%) | Notes |
| Kaolin | >98 | *Naturally occurring |
| 1332-58-7 | | chemical substance |
| | | per TSCA. 40 CFR |
| | | 710.4(b). |
| Titanium Dioxide | 0.4-2 | A naturally occurring |
| (Naturally Occurring) | | impurity in kaolin clay. |
| 13463-67-7 | | |

Median Particle Size (Microns): about 3.5

The median particle size of each respective kaolin clay was determined as follows: A sample of dry kaolin clay powder is mixed into water containing a small concentration of TSPP (tetrasodium pyrophosphate) used in sufficient quantity to fully deflocculate the sample. The dilute suspension of kaolin clay is then fully dispersed by using ultrasonic energy.

Particle size is determined using a Sedigraph (Micromeritics). This method measures the sedimentation rate of the clay particles and estimates particle size as the equivalent Stokes diameter.

The measured particle size may be method dependent for materials with plate-like particle morphology similar to kaolin clay. For example, the particle size measurement of EPK and ASP-400P have also been done using a Microtrac LS. This method employs similar sample preparation as the Sedigraph but uses laser light scattering to determine particle size. However, the measured particle size for samples given similar suspension preparation can be very different; Microtrac LS measures a median particle size of 4.8 micron (vs. Sedigraph 0.4 micron) for EPK and a median particle size of 5.3 micron (vs. Sedigraph 3.5 micron) for ASP-400P.

The foregoing kaolin clays are provided for purposes of illustration. Those having ordinary skill in the art will be aware of other kaolin clays having median particle sizes that are greater than, less than, or intermediate between the aforementioned exemplary kaolin clays, all of which may be suitable for use in manufacturing zeolitic adsorbents in accordance with various embodiments of the present disclosure. For example, while the first exemplary clay shown has a median particle size of about 0.4 microns, it is expected that clays having sizes from about 0.2 to about 0.6 microns, for example about 0.3 to about 0.5 microns, will exhibit similar properties. Likewise, while the second exemplary clay shown above has a media particle size of about 3.5 microns, it is expected that clays having sizes from about 3.2 to about 3.8 microns, for example about 3.4 to about 3.6 microns, will exhibit similar properties. Other sizes may be suitable for additional applications in accordance with the present disclosure.

Thus, from the information set forth above, it will be appreciated that the chemical composition of the kaolin EPK and kaolin ASP-400P are substantially similar. However, it will further be appreciated that the median particle sizes vary by a factor of greater than 2. Thus, the primary difference between kaolin EPK and kaolin ASP-400P is the median particle size of the clay particles. Experimentation was performed on zeolites produced with each of EPK and ASP-400P, the results of which are set forth in the Illustrative Examples section below.

Prior to the discussion of the above-noted experimentation, a brief overview of the manufacturing process for the production of zeolite adsorbents is provided. One exemplary process to produce the adsorbents with optimized performance characteristics according to the invention is described broadly as follows: First, the zeolite X and the kaolin clay binder are obtained and/or prepared. Second, the zeolite X and the kaolin clay binder are mixed to form a zeolite X/binder system. Thereafter, the zeolite X/binder system is dried and calcined. Then, the system undergoes a binder conversion process to convert the binder to additional zeolite. After binder conversion, the zeolite X/binder system is hydrated with water containing a lithium salt for the lithium ion exchange process, such that the system is exchanged with lithium cations to an amount that is at least about 75%. Finally, the ion-exchanged system is dried and calcined to form the adsorbent material blend as described in the present embodiments. Each step set forth initially herein is described in greater detail below.

Other processes can be utilized to form the zeolite X/binder system of the present disclosure, wherein the zeolite X is ion-exchanged to at least about 75% with lithium ions prior to or after the blending with the clay binder. Any such process for the ion exchange of the zeolite X and the blending of that ion exchanged zeolite X with the binder is within the scope of the present disclosure.

In accordance with the above-outlined adsorbent manufacturing process, once the appropriate zeolite X material is chosen for the given utilization, it is mixed with the binder, which can include kaolin clays of various median particle diameters. The amount of binder can range from about 2 to about 30 percent by weight, preferably from about 5 to about 20 percent, and most preferably in the range of about 10 percent of the composition as a whole, by weight. The percentage of binder present is adjusted depending on the percentage of the binder that includes one or more different types of kaolin clays. Sufficient water is retained in or added to the mixture to make a formable mixture, i.e., one that can be easily extruded or formed into the desired adsorbent shape, such as a bead shape.

The mixture is blended using a conventional blending device, such as a conventional mixer, until a mass of suitable viscosity for forming is obtained. The blended mixture is then formed into the appropriate shaped product. The products can be formed in any conventional shape, such as beads, pellets, tablets, or other such conventional shaped products. Once the formed products are produced into the appropriate shape, they are calcined, preferably at about 400° C. to about 800° C., such as about 600° C., for about 30 minutes to about 2 hours.

Once the shaped products are formed, they are subjected to a binder conversion process, wherein the kaolin binder material is converted to additional zeolite, thereby rendering the zeolitic adsorbents binderless. In one embodiment, caustic digestion of the formed particles (e.g., using sodium hydroxide) is employed to convert the zeolite X/binder system into a second zeolite X system, resulting in a binder-converted composition that may include zeolite X, with low or no detectable binder content. The Si/A1 framework ratio of the converted portion of zeolite X, as well as the contribution of this material in the final formulation, may be varied according to the type and amount of binder that is incorporated into the formed particles. Normally, the Si/Al ratio of the binder will be substantially conserved upon conversion into zeolite X. Thus, a typical kaolin clay having a Si/Al ratio in a range from 1.0 to 1.1 will convert to a zeolite X portion having a zeolite framework ratio within this range. It is possible, therefore, to prepare binder-converted compositions having first (prepared) and second (converted) portions of zeolite X with differing Si/Al ratios. In an alternative embodiment, it is possible to modify the procedure in which the binder is converted to zeolite X, in the synthesis of a binder-converted composition, to increase the silica to alumina molar ratio of the converted portion of zeolite X, if desired. This may be achieved through the addition of a silica source such as colloidal silica sol, silicic acid, sodium silicate, silica gel, or reactive particulate silica (e.g., diatomaceous earth, Hi-Sil, etc.). The silica source can be added during the adsorbent particle forming step, to the caustic digestion step, or both. The amount of silica added is such that the overall reaction mixture of binder (which it is noted has been converted to meta-kaolin in the preceding process step) and the silica source is controlled such that the reaction composition falls into the following range: Na₂O/SiO₂=0.8-1.5, SiO₂/Al₂O₃=2.5-5, H₂O/Na₂O=25-60. The use of a separate source of silica can therefore allow the preparation of a binder-converted composition in which the Si/Al ratio of both the prepared and converted portions of zeolite X are closely matched (e.g., are both within the range from 1.0 to 1.5, and normally from about 1.05 to 1.35), if desired. Further, the relative amounts of the first prepared and second converted portions of zeolite X in the binder-converted composition may be varied. According to some embodiments, the amount of binder used in the preparation of the formed particle will be in the range from about 5% to about 40% by weight, and preferably from about 10% to about 30% by weight. These ranges therefore also correspond to the amounts of converted zeolite X that is present in representative binder-converted compositions described herein. Preferably, the binder material content, after conversion to the second zeolite is in a range of from 0 to 3 wt. %. In exemplary binder-converted compositions, non-zeolitic material is substantially absent (e.g., is present in the composition generally in an amount of less than about 2% by weight, typically less than 1% by weight, and often less than 0.5% by weight).

Thereafter, the binder-converted compositions are hydrated with water containing a lithium salt, such as lithium chloride. The quantity of the lithium salt that is added should be sufficient to achieve the ion exchange that is desired using conventional ion exchange procedures well known to those having ordinary skill in the art. Once the ion exchange process has been completed to the extent required, the ion-exchanged zeolite X/clay binder blend is dried and calcined at a temperature of about 400° C. to about 800° C., such as about 600° C., for about 30 minutes to about 2 hours to produce the final zeolite adsorbent product.

### ILLUSTRATIVE EXAMPLES

The following examples are merely provided to illustrate exemplary implementations of a zeolitic adsorbents and methods for manufacturing the same. As such, the form and content of the various adsorbents are intended to serve only as non-limiting examples for the skilled artisan to better understand the properties thereof.

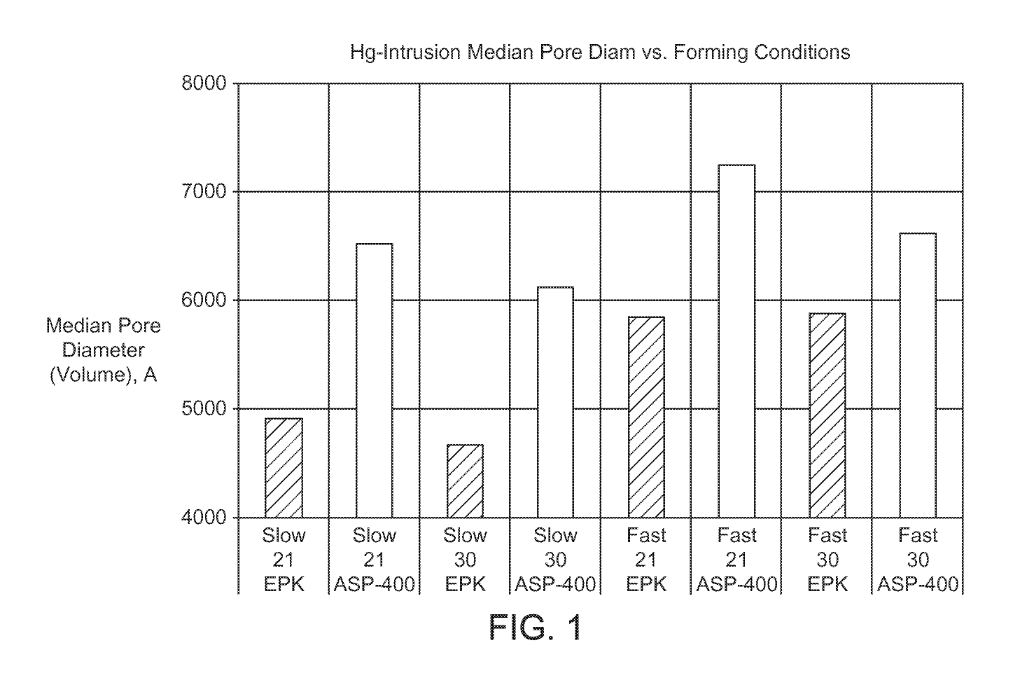

Various zeolitic adsorbents were prepared as described above. A first group of the zeolitic adsorbents were prepared using the kaolin clay binder EPK. A second group of the zeolitic adsorbents were prepared using the kaolin clay binder ASP-400P. All samples were binder-converted and lithium ion-exchanged. Each prepared adsorbent was subjected to median pore diameter measurement using Hg porosimetry. The results of such measurements are presented in FIG. 1. As shown in FIG. 1, for similar forming conditions (growth rate (slow/fast), blend moisture level (21%/30%), etc.), the adsorbents manufactured with the ASP-400P clay (having a relatively greater median particle diameter) exhibited a greater median pore diameter than similarly formed adsorbents manufactured with the EPK clay (having a relatively smaller median particle diameter).

Subsequent to the pore diameter measurements, the separation kinetics of each of the adsorbent samples in an oxygen/nitrogen separations process was measured using two different kinetics testing schemes. The samples were all formed to be approximately 1.8 mm diameter spherical beads (8×12 mesh).

In the first testing scheme, a plurality of adsorbent beads were loaded into an approximately 1″ diameter by 12″ long cylinder. The beads were purged with pure O₂ at 6.8 standard liters per minute (SLPM) flow rate for about 2 to 3 minutes to eliminate any N₂ that may have been adsorbed onto the beads. Subsequent to purging, 6.8 SLPM flow rate treated air (i.e., air having the CO₂ and H₂O components thereof previously substantially removed) at 1.5 bar and 25° C. was directed through the cylinder. An O₂ sensor was placed at the end of the cylinder to measure the O₂ content of the exiting air. For an initial period of time, the exiting gas is pure O₂ (i.e., the sensor measures about 100% O₂). At a time =t_{bt} (the “breakthrough time), after the beads have been partially loaded with N₂, the purity of the exiting gas drops below 100%, and thereafter continues downward until the feed composition matches the exiting composition. The time between 90% and 30% O₂, hereinafter referred to as Δt, is measured and recorded. The O₂ curve is integrated over Δt and subtracted from the flow rate to determine the N₂ capacity (with corrections being made for void space within the cylinder and between the adsorbent beads). The Relative Rate (RR), measured in mmol/g/s, was calculated as follows:

$$RR = \frac{{N}_{2} Capacity}{Δ t}$$

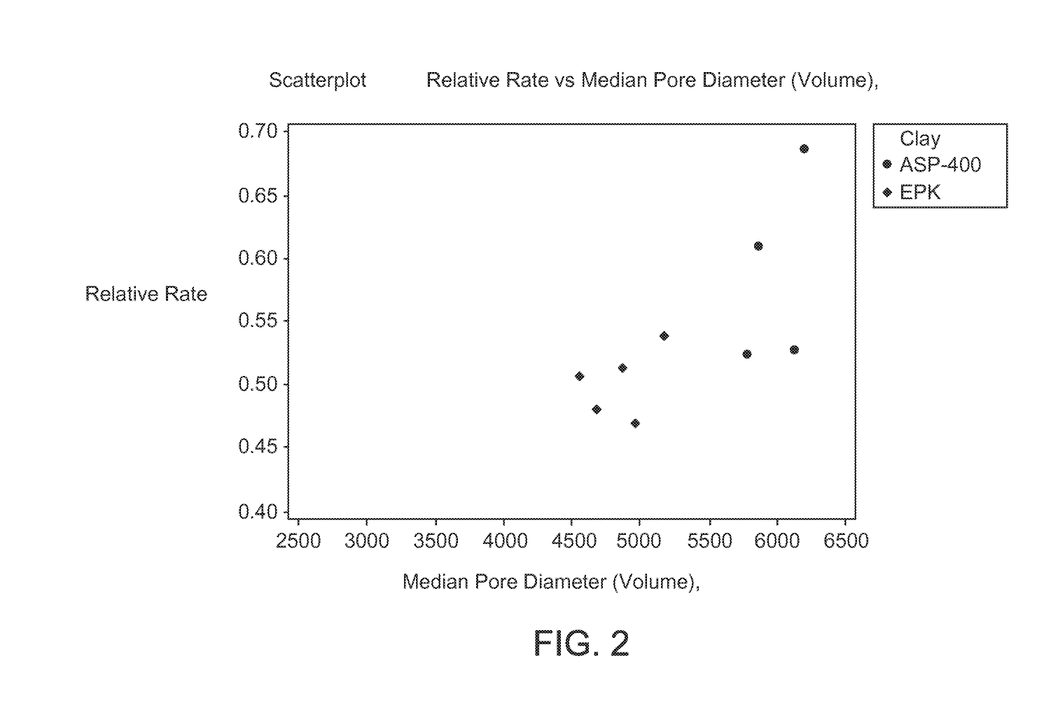

In this testing scheme, the adsorbents manufactured with the ASP-400P kaolin clay had significantly greater RR kinetics compared to the adsorbents manufactured with the EPK kaolin clay when the other variables were held constant. Again, the primary difference between the zeolites being that the porosimetry data indicated that ASP-400P samples all had larger median pore sizes than the EPK samples. In particular, FIG. 2 shows a positive correlation between the RR adsorption kinetics measurement and the median pore size for the samples. Thus, RR shows a positive correlation with the median pore diameter as measured by the porosimetry test shown in FIG. 1.

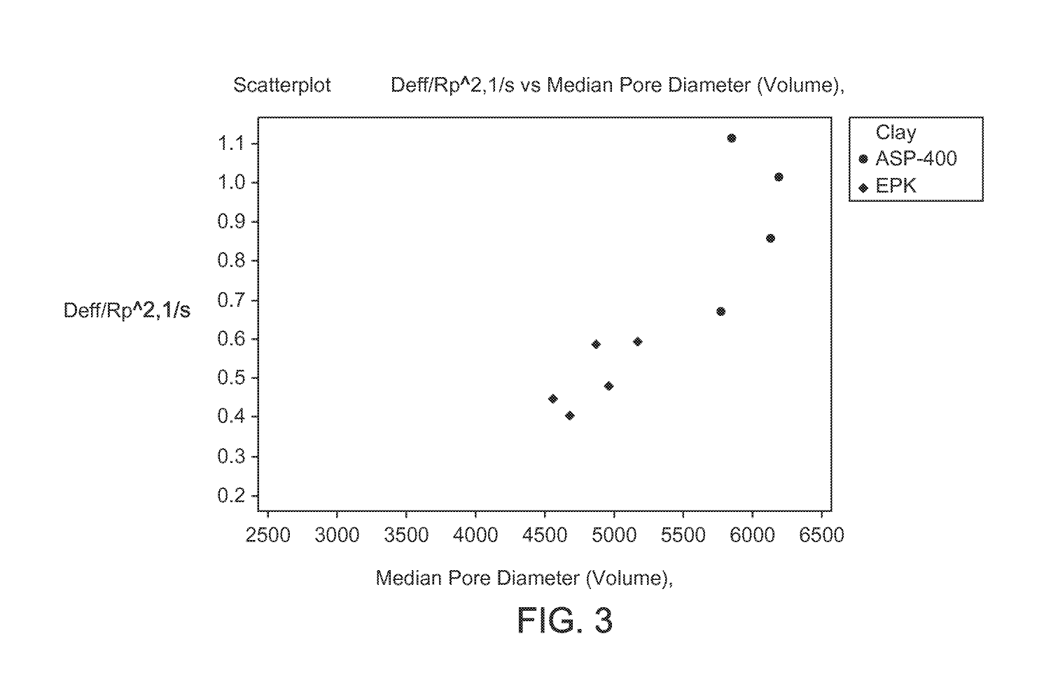

In the second testing scheme, which is hereinafter referred to as a dynamic response test (DRT), a plurality of beads were loaded into a first enclosed volume. The first enclosed volume was evacuated to create substantially vacuum conditions therein. The first enclosed volume was connected to a second enclosed volume. The second enclosed volume contained an amount of nitrogen. The first and second enclosed volumes were initially separated by a sealing means to prevent flow of the nitrogen from the second enclosed volume to the first enclosed volume. Thereof, the sealing means was removed to allow nitrogen to flow between the volumes. A pressure sensor is used to monitor the adsorption process. The faster the pressure reaches the equilibrium pressure the faster the kinetics. The lower the equilibrium pressure the higher the capacity of the adsorbent. In particular, the results of this testing scheme provide an approximation to the effective diffusivity (D_{eff}) of the adsorbent bead per radius squared thereof (rₚ²) (in units of s⁻¹). The results of this testing scheme are illustrated in FIG. 3. As shown therein, using this testing scheme, there is an even stronger dependence of the kinetic parameter and the median pore size, as compared to the first testing scheme.

Thus, the above experimentation indicates that the adsorption rate kinetics can be tailored to a particular application using the median particle diameter of the clay binder material as the controlled variable. Where higher adsorption rates are desired, kaolin clays such as ASP-400P, having a median particle diameter of about 3.5 microns, can be used, whereas if lower adsorption rates are desired, kaolin clays such as EPK, having a median particle diameter of about 0.4 microns, can be used. Of course, various ratios of mixtures of EPK and ASP-400P clays can be envisioned wherein intermediate adsorption rates are desired. Further, other kaolin clays not specifically mentioned herein (but that will be known to those having ordinary skill in the art) that have larger, smaller, or intermediate median particle sizes may be selected to achieve a desired adsorption rate in accordance with the teachings of the above illustrative examples.

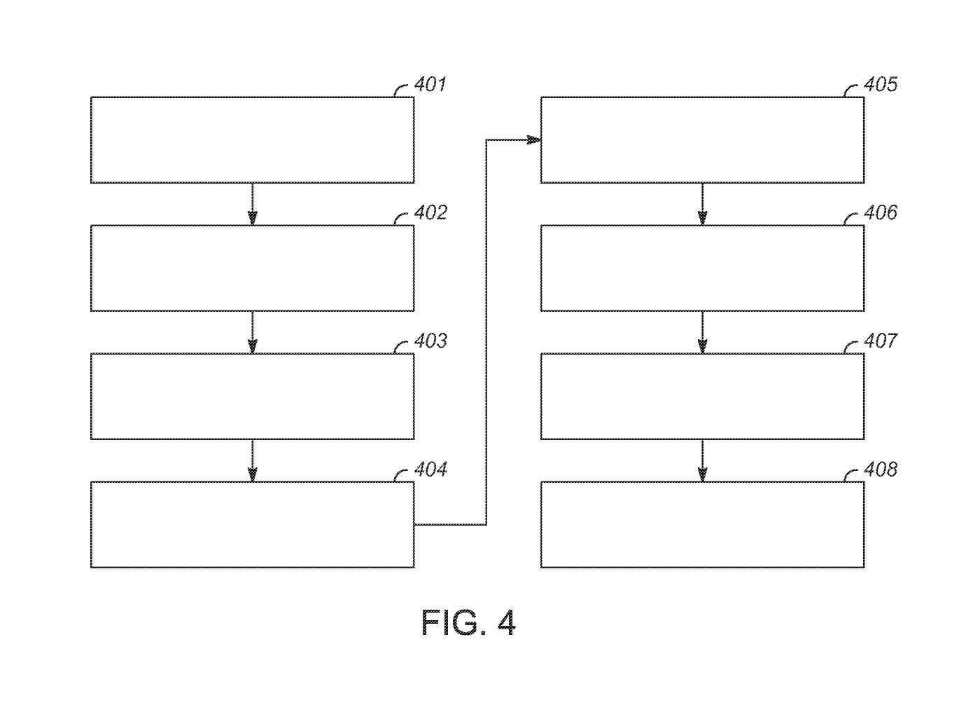

An exemplary method of producing a zeolitic adsorbent in accordance with the foregoing is present in FIG. 4. As shown therein, in one exemplary embodiment of the present disclosure, a method for producing a zeolitic adsorbent includes, at step 401, providing a zeolite material. At step 402, the method includes providing a first clay binder material and a second clay binder material, the first clay binder material having a greater median particle size than the second clay binder material. At step 403, the method includes determining a desired adsorption kinetics rate for the zeolitic adsorbent, wherein the desired adsorption kinetics rate is based at least in part on a separations process in which the zeolitic adsorbent is desired to be employed. At step 404, the method includes selecting either the first clay binder material or the second clay binder material based at least in part on the determined desired adsorption kinetics rate. Further, at step 405, the method includes blending the zeolite material and the selected first or second clay binder material to form a zeolite/binder blended system. At step 406, the method includes forming a plurality of shaped pieces from the zeolite/binder blended system. At step 407, the method includes binder-converting the clay binder material into a zeolite material. Still further, at step 408, the method includes ion-exchanging the shaped pieces with an exchange cation to form an ion-exchanged adsorbent.

As such, disclosed herein are various embodiments of a method for manufacturing zeolitic adsorbents wherein the selection of the clay particle size is used to optimize the pore network and enhance the kinetics of the material by controlling the piece density and the median pore diameter. The manufacturing methods disclosed herein may be used to manufacture zeolitic adsorbents that exhibit optimal adsorption rate kinetics for the particular application in which they are desired to be employed.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of this disclosure.

What is claimed is:

1. A method for producing a zeolitic adsorbent comprising the steps of:
providing a zeolite material;
providing a first clay binder material and a second clay binder material, the first clay binder material having a greater median particle size than the second clay binder material;
determining a desired adsorption kinetics rate for the zeolitic adsorbent, wherein the desired adsorption kinetics rate is based at least in part on a separations process in which the zeolitic adsorbent is desired to be employed;
selecting either the first clay binder material or the second clay binder material based at least in part on the determined desired adsorption kinetics rate;
blending the zeolite material and the selected first or second clay binder material to form a zeolite/binder blended system;
forming a plurality of shaped zeolitic adsorbent pieces from the exchanged zeolite/binder blended system;
binder-converting the clay binder material into a zeolite material; and
ion-exchanging the binder-converted shaped pieces with an exchange cation to form an ion-exchanged zeolite/binder blended system.

2. The method of claim 1, wherein providing the zeolite material comprises providing an x-type zeolite material.

3. The method of claim 1, wherein providing the first clay binder material comprises providing a kaolin clay binder material.

4. The method of claim 3, wherein providing the first clay binder material comprises providing a kaolin clay binder material having a median particle size of about 3.2 to about 3.8 microns as determined by sedimentation rate.

5. The method of claim 1, wherein providing the second clay binder material comprises providing a kaolin clay binder material.

6. The method of claim 5, wherein providing the second clay binder material comprises providing a kaolin clay binder material having a media particle size of about 0.2 to about 0.6 microns as determined by sedimentation rate.

7. The method of claim 1, wherein determining the desired adsorption kinetics rate is based at least in part on an oxygen/nitrogen pressure swing adsorption separations process.

8. The method of claim 1, further comprising drying and calcining the zeolite/binder blended system.

9. The method of claim 1, further comprising drying and calcining the ion-exchanged zeolite/binder blended system.

10. The method of claim 1, wherein ion-exchanging the zeolite/binder blended system comprising ion-exchanging with lithium cations.

11. The method of claim 1, wherein forming the plurality of zeolitic adsorbent pieces comprises forming a plurality of bead-, pellet-, or tablets-shaped zeolitic adsorbent pieces.

12. The method of claim 1, wherein the first clay binder material is selected based on a relatively faster desired adsorption kinetics rate.

13. The method of claim 1, wherein the second clay binder material is selected based on a relatively slower desired adsorption kinetics rate.

14. A zeolitic adsorbent comprising:
a zeolite material; and
a clay binder material,
wherein:
the clay binder material is selected from a group consisting of a first clay binder material and a second clay binder material, the first clay binder material having a median particle size that is at least double the median particle size of the second clay binder material,
the clay binder material is selected based at least in part upon an adsorption kinetics rate of a separations process in which the zeolitic adsorbent is desired to be employed,
the zeolite material and the clay binder material are blended together to form a zeolite/clay binder system,
the zeolite/clay binder system is binder-converted to form a binder-converted zeolite material, and
the binder-converted zeolite material is ion-exchanged with an exchange cation to form a binderless, ion-exchanged, zeolitic adsorbent.

15. The zeolitic adsorbent of claim 14, wherein the zeolite comprises an X-type zeolite.

16. The zeolitic adsorbent of claim 14, wherein the first clay binder material comprises a median particle size of about 2.2 to about 2.8 microns as determined by sedimentation rate.

17. The zeolitic adsorbent of claim 16, wherein the second clay binder material comprises a median particle size of about 0.2 to about 0.6 microns as determined by sedimentation rate.

18. The zeolitic adsorbent of claim 14, wherein the adsorption kinetics rate is based at least in part on an oxygen/nitrogen pressure swing adsorption separations process.

19. The zeolitic adsorbent of claim 14, wherein the exchange cation is a lithium cation.

20. The zeolitic adsorbent of claim 14, wherein the first clay binder material is selected for a process with a relatively faster desired adsorption kinetics rate and wherein the second clay binder material is selected for a process with a relatively slower desired adsorption kinetics rate.
